(19) United States
(12) Patent Application Publication
(10) Pub. No.: US 2009/0205309 A1
(43) Pub. Date: Aug. 20, 2009

(54) Method for controlling the combustion in a combustion chamber and combustion chamber device

(75) Inventor: Berthold Noll, Offenburg (DE)

Correspondence Address: Lipsitz & McAllister, LLC, 755 MAIN STREET, MONROE, CT, 06468, US

(73) Assignee: Deutsches Zentrum fuer Luft- und Raumfahrt e.V., Koeln (DE)

(21) Appl. No.: 12/380,288

(22) Filed: Feb. 24, 2009

Related U.S. Application Data
(63) Continuation of application No. PCT/EP2007/007537, filed on Aug. 29, 2007.

(30) Foreign Application Priority Data
Aug. 30, 2006 (DE) 10 2006 041 955

(51) Int. Cl. F02C 7/057; F02C 3/32

(52) U.S. Cl. 60/39.23; 60/748

(57) ABSTRACT

There is provided a method for controlling the combustion in a combustion chamber with a combustion space, wherein fuel in fluid form and oxidiser in fluid form are blown into the combustion space, in which at least one control jet is generated in the combustion space, which influences the flow of fuel and/or oxidiser in the combustion space, wherein the mass flow component of the at least one control jet lies between 1% and 7% of the total mass flow, the at least one control jet is generated such that it varies over time, the at least one control jet is generated by being blown in or extracted through one or more ports in a combustion chamber wall, which coincide with one or more ports for blowing in and/or extracting fuel and/or oxidiser, and the at least one control jet is generated so that a degree of swirl of the fuel flow and/or oxidiser flow is reduced by means thereof.

This application is a continuation of international Application number PCT/EP2007/007537 filed on Aug. 29, 2007.

The present disclosure relates to the subject matter disclosed in international application number PCT/EP2007/007537 of Aug. 29, 2007 and German application number 10 2006 041 955.3 of Aug. 30, 2006, which are incorporated herein by reference in their entirety and for all purposes.

### BACKGROUND OF THE INVENTION

The invention relates to a method for controlling the combustion in a combustion chamber with a combustion space, wherein fuel in fluid form and oxidiser in fluid form are blown into the combustion space.

The invention additionally relates to a combustion chamber device comprising a combustion space for the combustion of fuel and oxidiser and a blowing device, by means of which fuel in fluid form and oxidiser in fluid form can be blown into the combustion space.

A fuel injector for feeding a fuel-air mixture into a combustion chamber is known from patent EP 1 040 298 B1. Means for mixing the air and fuel during flow through the fuel injector as well as means for swirling the air during flow through the fuel injector are provided. In addition, flow control means with at least one control port are provided, so that a change in flow of the control air flowing through the control port causes a change in the degree of swirl and the flow resistance, to which the combustion air is subjected during its flow through the fuel injector.

A combustion chamber of a gas turbo assembly is known from patent document DE 196 14 001 A1, in which flow conduits for the throughflow of a portion of the entire air-fuel mixture branch off in the end phase of a mixing section, and wherein the flow conduits open into an outer circulation zone.

A method for flame stabilisation of premix burners in plants for heat generation are known from patent document DE 44 08 256 A1, in which at least one gaseous medium is sprayed into the premix burner transversely to the combustion mixture.

A combustion chamber for gas turbines is known from DE 1 947 762, which comprises a primary air inlet guide, secondary air inlet nozzles and diluting air nozzles, wherein the respective air inlet point contains a fluidic air flow regulator means that is arranged so that the parts of the total air flow entering through the respective air inlet points are variable without changing the total resistance of the combustion chamber to the air flow flowing through.

A burner arrangement, in particular for gas turbine plants, is known from DE 1 751 838, which has a means that directs a component of the inlet air flow into a combustion zone inside the combustion chamber.

A combustion chamber for liquid and gaseous fuels for continuous combustion with a flame tube arranged inside the outer housing of the combustion chamber is known from DE 26 38 878 A1. Combustion gases are directed back in the flame tube because of the injector effect of the injected air.

A method for reducing smoke development while maintaining the other operating parameters of a combustion chamber is known from DE 1 951 198, in which a first flow of primary air in the order of 6% to 8% of the total air flow is directed to the upstream end of the combustion zone, the pressure of the first flow is increased, and the flow is directed radially inwards, a second primary air flow in the order of 1% to 30% of the total air flow is directed to the upstream end of the combustion zone by a feeding means, a swirling movement is generated in the second flow and this second flow is directed into the combustion chamber in a plane substantially parallel to the axis of the feeding means, fuel is injected into the first and second flows, and the fuel-air mixture is combusted.

A gas turbine combustion stabiliser comprising at least one turbulence promoter is known from patent U.S. Pat. No. 5,575,153 A.

### SUMMARY OF THE INVENTION

In accordance with the present invention, a method is provided with which the combustion in the combustion chamber can be controlled so that optimised ignition conditions and/or combustion conditions result.

In accordance with an embodiment of the invention at least one control jet is generated in the combustion space, which influences the flow of fuel and/or oxidiser in the combustion space, and wherein the at least one control jet is generated such that it varies over time.

At least one control jet is generated in the combustion chamber, which influences the flow conditions in the combustion space and in particular the flow conditions of fuel and oxidiser. By appropriate adjustment of the control jet, for example, the ignition behaviour can be improved in particular by the fuel component of a mixture of fuel and oxidiser being increased in the vicinity of an ignition device. Moreover, it is also possible to increase the residence time for fuel and oxidiser in the combustion space. In addition, it is possible to prevent a flame core from being quenched and a flame core from being flushed out.

It is possible, for example, to obtain an optimised ignition behaviour, even if an ignition device cannot be positioned at an optimum position because of structural limitations.

If, for example, fuel in liquid form is blown into a combustion space, then the problem results, in particular when supplying relatively cold oxidiser (e.g. by means of air), that the ignition device must be positioned at a location at which a sufficiently large amount of vaporised fuel is available. The fuel must in turn have a specific minimum residence time in the combustion space in order to vaporise. The length of the combustion space when using liquid fuel is then determined by the requirements of the ignition process. As a result of the solution of the invention the combustion space can also be minimised when using liquid fuel, since an optimised fuel-oxidiser mixture can be supplied to an ignition device by means of the at least one control jet. As a result, the method according to the invention can be advantageously used in an aircraft engine, for example.

In accordance with an embodiment of the invention, the combustion can be optimised with respect to optimum flow conditions for the ignition, for example, without there being substantial negative effects on the combustion stability and pollutant emission. (Without the teaching of the present invention long residence times are favourable for ignition, whereas long residence times are more likely to be unfavourable for pollutant emission.)

In accordance with an embodiment of the invention it is provided in particular that the at least one control jet is only generated during the ignition phase. As a result, the flow conditions are also only changed during the ignition phase.

The method in accordance with the invention can be used in association with gaseous and liquid fuels and gaseous and liquid oxidisers. Fuel and oxidiser can be premixed or only partially premixed. Mixing can also occur first of all in the combustion space. The method according to the invention can be used for all types and sizes of burner systems. For example, it can be used for small burners such as in domestic burner systems. It can also be used for the combustion chambers of stationary gas turbines or for aircraft engines.

In this case, the mass flow of the at least one control jet can be kept low (in particular less than 25% and, for example, between approximately 1% and 7% of the total mass flow), since substantially this only has to influence the flow conditions for fuel and oxidiser and in particular has to influence the boundary conditions thereof, while not itself having any substantial effect on combustion.

A jet can already be generated before entering the combustion space and then becomes the control jet on entry into the combustion space. As a result, the control jet is generated in the combustion space.

In principle, it can be provided that the at least one control jet is generated in continuous operation. It is advantageous if the at least one control jet is generated so that it varies over time. This enables the ignition behaviour to be optimised, for example. After ignition has occurred, the control jet is switched off. It is also possible, for example, to adapt the at least one control jet to the load state of the combustion chamber. This also enables an adaptation to load change processes. For example, the at least one control jet is generated during a load change process. As a result, the combustion chamber can again be operated in an optimum manner.

In accordance with an embodiment of the invention, a control jet can be generated for a limited time and this then accordingly influences the flow conditions in the combustion chamber with respect to time. In particular, the fuel component of a mixture of fuel and oxidiser is increased in the vicinity of the ignition device during the ignition phase. Moreover, the residence time for fuel and oxidiser in the combustion space can be increased during the ignition phase.

In particular, the combustion in the combustion space is controlled by controlling the flow conditions in the combustion space by means of the at least one control jet.

It is favourable if the at least one control jet is a fluid jet. This enables the flow conditions to be influenced in a simple manner.

The control jet can be a gas jet or liquid jet or two-phase jet of gas and liquid. The suitable jet form can be selected according to the application.

In one embodiment, the at least one control jet is a suction jet, which is generated by (locally) applying an underpressure to the combustion space. By applying an underpressure to the combustion space, medium is extracted from the combustion space and the suction jet is thus generated as control jet. With appropriate generation of the suction jet the flow conditions in the combustion chamber can be positively influenced.

In a further embodiment, which can also be combined with a separate suction jet, the at least one control jet is a blow jet, which is generated by blowing one or more media into the combustion space. This allows optimum influence on the flow conditions in particular with respect to the ignition behaviour. For example, a backflow zone can be expanded at an ignition device.

In its configuration as blow jet, the at least one control jet can be generated in various ways. For example, it is generated by blowing fuel or one or more fuel components into the combustion space. It can also be generated by blowing oxidiser into the combustion space. In principle, it is also possible that the at least one control jet is generated by blowing a fuel-oxidiser mixture into the combustion space. It can also be generated by blowing one or more media, which do not participate in the combustion, into the combustion space. For example, an inert gas such as nitrogen is blown in or water in vapour form is blown in or sprayed in droplets.

It is provided that the fuel is blown into the combustion space as gas or as liquid or as two-phase mixture. As a result, a flow is formed in the combustion space, and the at least one control jet can in turn influence the flow, for example, to optimise the ignition behaviour.

It can be advantageous if the fuel and/or oxidiser are blown into the combustion space with swirl. An optimised mixing results from this.

It is especially advantageous if the at least one control jet is spatially defined. Depending on the application, optimised flow conditions result from this to achieve an optimised ignition behaviour, for example, while minimising the combustion space length.

In one embodiment, the at least one control jet is directed at least approximately parallel to an axis of the combustion space and/or a burner. An axially extending control jet in the form of a blow jet or suction jet is generated as a result of this. As a result of such an axially directed control jet, for example, a backflow zone can be expanded such that an optimised ignition can occur.

It is especially advantageous if the at least one control jet is generated so that one or more backflow zones in the combustion space are modified and expanded, for example, at least in their axial extent in comparison to the control jet-free state. As a result, an ignition device that may not be optimised can also be supplied with fuel-oxidiser mixture to obtain an ignition for the combustion.

It is then advantageous if the at least one control jet is generated so that one or more backflow zones are expanded in the vicinity of a wall of the combustion chamber. This allows optimum application, during an ignition phase, of fuel-oxidiser mixture to an ignition device positioned on the wall.

It is advantageous if the at least one control jet is generated so that by means thereof an increase in residence times in the combustion space by more than 1 ms occurs for an amount of fuel or an amount of oxidiser blown in compared to the control jet-free state. This allows the combustion conditions and in particular the ignition conditions in the combustion space to be optimised.

For the same reason it is advantageous if an increase in residence times by more than 3 ms, and in particular more than 5 ms, and advantageously more than 10 ms, occurs in comparison to the control jet-free state. This allows an optimised ignition with minimised combustion space length to also be achieved when liquid fuel is used.

It is especially advantageous if the at least one control jet is generated so that flushing of a flame core out of the combustion space is prevented by means thereof. This results in optimised combustion conditions. In particular, it is ensured by means of the at least control jet that a flame core moves in a flow region, in which an ignition of a primary flame can occur.

For the same reason it is advantageous if the at least one control jet is generated so that quenching of a flame core is prevented by means thereof. This results in stable combustion conditions in the combustion space.

Quenching of a flame core can be prevented by the generation of turbulent flow conditions in the region of an ignition device.

It can be provided that the at least one control jet is generated so that a degree of swirl of the fuel flow and/or oxidiser flow is reduced by means thereof. Fuel flows and/or oxidiser flows with swirl are particularly sensitive to the boundary conditions. These boundary conditions can be influenced in a simple manner by means of the at least one control jet. For example, the degree of swirl is reduced. As a result of this, an optimised control of the combustion is the combustion space can be obtained in a simple manner with a relatively low fluid amount (that lies, for example, between 1% and 20%, and in particular 2% and 20%, and preferably between 1% and 7% of the total mass flow) for the control jet.

It can also be provided that the at least one control jet is generated with swirling flow in order to obtain an optimised control of the combustion (in particular during the ignition phase) depending on the application.

In a structurally simple embodiment, the at least one control jet is generated by being blown in or extracted through one or more ports in a combustion chamber wall. Such ports can be produced in a simple manner.

It can be provided that the port or ports for the control jet are separated from the port or ports for blowing in and/or extracting fuel and oxidiser.

It is also possible that the at least one control jet is generated at a port or at ports for blowing in and/or extracting fuel and/or oxidiser. For this, control jet medium is blown into a corresponding conduit in front of such a port, for example, and is then blown into the combustion space with fuel and/or oxidiser. As a result of this, for example, the entry speed of the fuel flow can be increased and/or the degree of swirl of the oxidiser flow can be reduced.

A port is, or the ports are, circular or ring-shaped, for example, wherein the port shape can be adapted to the application. For example, square, crescent-shaped, elliptic, rectangular etc. port shapes are also possible.

It is particularly advantageous if the generation of the at least one control jet can be switched on and switched off. As a result, it is possible, for example, to switch off, after ignition has occurred, a control jet that has served to improve the ignition behaviour.

In particular, one or more valves are provided for switching on and switching off the at least one control jet. This allows a switch-on and switch-off control for the at least one control jet to be achieved in a simple manner.

In particular, the at least one control jet generated is controlled by means of the load state. The control is this case is primarily a time control. If a plurality of control jets can be generated, then the selection of the control jets can also be controlled by means of the control device. For example, it is also possible that the at least one control jet is switched on in normal operation and only switched off during an ignition phase in order to obtain optimum flow conditions for the ignition. For example, the at least one control jet can be temporarily extinguished (switched off) by extraction.

It is also possible that the at least one control jet generated is time-pulsed. This enables vibrations to be generated inside the combustion space, for example. As a result of these, the combustion stability can be increased and/or the mixture of fuel and oxidiser in the combustion space can be improved.

In one embodiment, the at least one control jet is generated between a centre axis of the combustion space and/or a burner and an injection region for fuel and/or oxidiser.

In a further embodiment, the at least one control jet is generated between an injection region for fuel and/or for oxidiser into the combustion space and a combustion chamber wall. A combination of these generation possibilities is also possible. As a result, optimised conditions are obtained depending on the special application.

It can be provided that the combustion chamber is comprised in a gas turbine. The gas turbine can be operated optimally as a result.

In an exemplary embodiment, the combustion chamber is comprised in an aircraft engine. If the method according to the invention is used, the combustion space can be configured with minimised length without impairing the ignition behaviour.

In particular, the at least one control jet can be used for ignition and/or re-ignition of the fuel-oxidiser mixture in the combustion space. An ignition and/or re-ignition is also possible at high altitude (cruising altitude), in which the oxidiser temperature is reduced.

It is advantageous if the amount of medium of the at least one control jet lies between 1% and 20%, and in particular between 2% and 20% and preferably between 1% and 7% of the total mass flow (through the combustion space). This allows the flow conditions in the combustion space to be influenced in an optimised manner with a relatively low medium amount.

In accordance with the invention, a combustion chamber device is provided, which can be operated in an optimised manner.

In accordance with an embodiment of the invention, a control jet generating device is provided, by means of which at least one control jet can be generated in the combustion space, by which the course of flow of fuel and/or oxidiser in the combustion space can be influenced, and a control device, by means of which the generation of control jets can be temporally controlled, is provided.

The combustion chamber device in accordance with the invention has the advantages already explained in association with the method in accordance with the invention.

In particular, the method in accordance with the invention can be conducted in the specified combustion chamber device.

Further advantageous embodiment have already been explained in association with the method in accordance with the invention.

In particular, the control jet generating device has an underpressure application device for generating at least one suction jet as control jet. This enables media to be extracted from the combustion space to generate the control jet.

In a further embodiment, the control jet generating device has a pressure application device for generating at least one blow jet as control jet. The pressure application device enables one or more media to be directed into the combustion space to generate one or more control jets.

It is advantageous if at least one port for the at least one control jet opens into the combustion space. This enables a control jet to be generated in the combustion space in a simple manner.

The at least one port for the at least one control jet can be separate from the port or ports of the blowing device for fuel and oxidiser. This allows the flow conditions of fuel and oxidiser in the combustion space to be influenced in an optimised manner. For example, the degree of swirl for a fuel flow and/or oxidiser flow can be reduced.

It is also possible that the at least one port for the at least one control jet is a port of the blowing device for fuel and oxidiser. As a result, the flow conditions of the fuel flow or oxidiser flow or mixed flow can already be influenced as they are blown in.

It can be provided that the at least one port for the control jet is circular or ring-shaped.

It is especially advantageous if one or more switchable valves such as magnetic valves, for example, are associated with the at least one port. As a result, the generation of one or more control jets can be switched on or switched off. A time control of the application of the control jet to the combustion space is possible as a result of this.

In an embodiment the at least one port is arranged on a front side of the combustion space. As a result of this, the flow conditions in the combustion space are influenced in an optimised manner by one or more control jets.

In this case, it is provided that a normal of a port surface of the at least one port is oriented substantially parallel to a combustion space axis. A control jet with axial flow direction can be generated as a result.

In an exemplary embodiment an ignition device is provided, which is arranged on a side of the combustion chamber device, which is transverse to a front side. The ignition device can be optimised to the combustion chamber device in a simple manner as a result. In accordance with the invention, with the generation of one or more control jets an optimised fuel-oxidiser mixture can be fed to the ignition device.

The generation of control jets can be controlled by a control device. This allows adaptation to the currently effective conditions. For example, the generation of a control jet can be switched off after ignition has occurred. An adaptation to transient load changes, for example, is also possible.

The combustion chamber device comprises in particular one or more burners (and at least one combustion chamber), one burner being provided in particular by an injection head.

The combustion chamber device according to the invention can also be advantageously used for a gas turbine.

The combustion chamber device according to the invention can also be advantageously used for an aircraft engine. The combustion space can be configured with a minimised length, since the ignition conditions can be optimised by the application of the control jet to the combustion space. An ignition or re-ignition for the combustion in the combustion space is also possible at high altitudes with a reduced amount of oxidiser (reduced air component).

The following description of preferred embodiments serves to explain the invention in more detail in association with the drawings.

### BRIEF DESCRIPTION OF THE DRAWINGS

FIG. 1 is a schematic representation in partial section of an exemplary embodiment of a combustion chamber device known from the prior art;

FIG. 2 is a schematic representation in partial section of a first exemplary embodiment of a combustion chamber device according to the invention;

FIG. 3 is a schematic representation in partial section of a second exemplary embodiment of a combustion chamber device according to the invention; and

FIG. 4 is a schematic representation in partial section of a third exemplary embodiment of a combustion chamber device according to the invention.

### DETAILED DESCRIPTION OF THE INVENTION

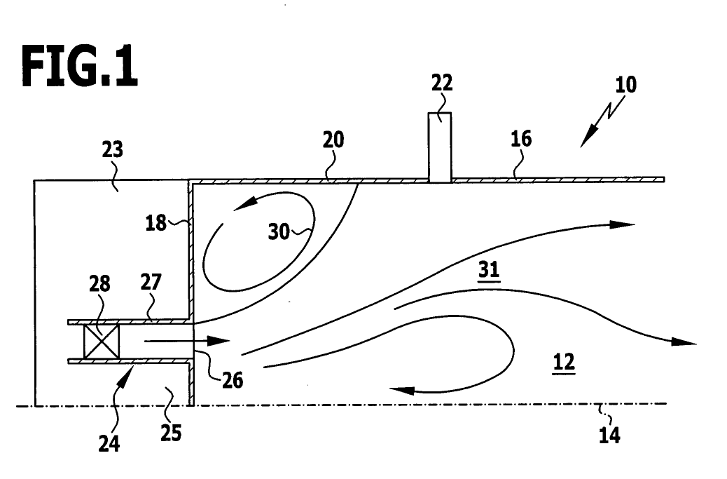

An exemplary embodiment of a known combustion chamber device, which is shown schematically in partial section in FIG. 1 and given the reference 10 there, comprises a combustion space 12 with a combustion space axis 14. The combustion space axis 14 is a centre axis of the combustion space 12 and in particular an axis of symmetry. The combustion space 12 is rotationally symmetric to the combustion space axis 14.

The combustion space 12 is arranged inside combustion chamber walls 16, wherein the combustion chamber walls 16 comprise a combustion chamber wall 18 on the front side and a transverse combustion chamber wall 20 lying transversely thereto. The combustion chamber wall 20 is a cylindrical wall, for example, which is perpendicular to the combustion chamber wall 18 on the front side. The combustion chamber wall 18 on the front side is then circular disc-shaped, for example.

In the exemplary embodiment shown in FIG. 1, the combustion space 12 is cylindrical. Other combustion space forms are also possible.

An ignition device 22 for igniting a fuel-oxidiser mixture is arranged on the transverse combustion chamber wall 20.

The combustion chamber 10 comprises an injection head 23 with a blowing device 24, by means of which fuel and oxidiser can be blown into the combustion space 12 respectively in fluid form. The injection head 23 forms one or more burners. (A burner 25 is present in the shown exemplary embodiment). In this case, the fuel can be gaseous or liquid, or it can consist of a two-phase mixture of gas and liquid. The oxidiser can be blown in in gas form or as a liquid or as a two-phase mixture of gas and liquid. In addition, the fuel and oxidiser can be completely premixed, partly premixed or blown in separately without premixing by means of the blowing device 24.

The fuel itself can be a single-component or multicomponent fuel, i.e. comprise a multiplicity of fuel components.

In the shown exemplary embodiment the blowing device comprises an (inlet) port 26, through which a mixture of fuel and oxidiser can be blown in. In this case, the inlet port 26 is arranged offset in relation to the combustion space axis 14. A normal of the inlet port area lies substantially parallel to the combustion space axis 14. Fuel and oxidiser are fed to the port 26 through a conduit 27.

A flow swirler 28 is associated with the blowing device 24.

By blowing fuel and oxidiser into the combustion space 12 a corresponding fuel flow and oxidiser flow is formed therein. This is indicated in FIG. 1. If a mixture of fuel and oxidiser is blown in, then a corresponding mixed flow is formed.

In this case, backflow zones 30 can be formed, in which the flow reverses its direction and flows back to the combustion chamber wall 18 on the front side. The backflow zones 30 are preferably formed on the transverse combustion chamber wall 20, which can cause a flow deflection.

As a result of the formation of (relatively short) backflow zones 30 the problem can arise that the ignition in the combustion space 12 is rendered more difficult, since the amount of fuel and/or oxidiser that flows past the ignition device 22 is reduced. Moreover, once formed, a flame core can flow to a combustion chamber outlet, so that a primary flame in a main reaction zone 31 (where the primary flame burns stably) is not ignited.

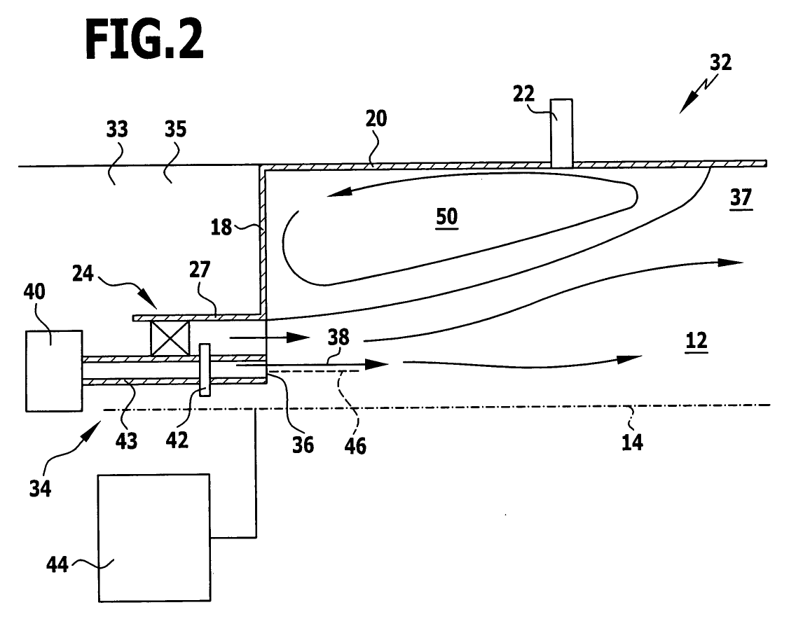

A first exemplary embodiment of a combustion chamber device according to the invention, which is shown in a schematic representation in partial section in FIG. 2 and is given the reference 32 there, is a modification of the combustion chamber device 10. Therefore, the same reference numerals are used for the same elements as in the combustion chamber device 10.

The combustion chamber device 32 comprises an injection head 33 with a control jet generating device 34, by means of which (at least) one control jet can be blown into the combustion space 12 in the form of a blow jet, and a combustion chamber 37, in which a combustion space 12 is formed and on which the injection head 33 sits. One or more burners 35 are formed by the injection head 33. One or more ports 36, through which one or more media can be blown into the combustion space, are associated with the control jet generating device 34. The port or ports 36 are inlet ports. As a result, a control jet 38 can be generated in the combustion space 12 that is a jet of the blown-in medium or of the blown-in media. The flow of fuel and/or oxidiser in the combustion space 12 can be influenced by means of this control jet 38.

The control jet generating device 34 has a pressure application device 40, by means of which the medium or media can be blown into the combustion space 12 as a blow jet in order to generate the control jet (or control jets). The pressure application device 40 comprises a pressure reservoir for the control jet medium and/or one or more pumps, for example.

The port 36 has an associated switchable valve 42 and in particular a magnetic valve, by means of which the generation of a control jet 38 can be switched on and switched off. The valve 42 is arranged on a conduit 43 in particular set back with respect to the port 36. With axial orientation of this conduit 43 an axial control jet can be generated in a simple manner. In addition, the action of heat on the valve 42 is reduced.

A control device 44 is coupled to the switchable valve 42 and actuates this. Thus, the generation of a control jet 38 can be controlled by means of the control device 44.

The port 36 has a port surface, the normal direction 46 of which is at least approximately parallel to the combustion space axis 14. This allows the control jet 38 generated in the combustion space 12 to be directed in axial direction.

In the shown exemplary embodiment, the port 36 is arranged between the inlet port 26 of the blowing device 24 and the combustion space axis 14.

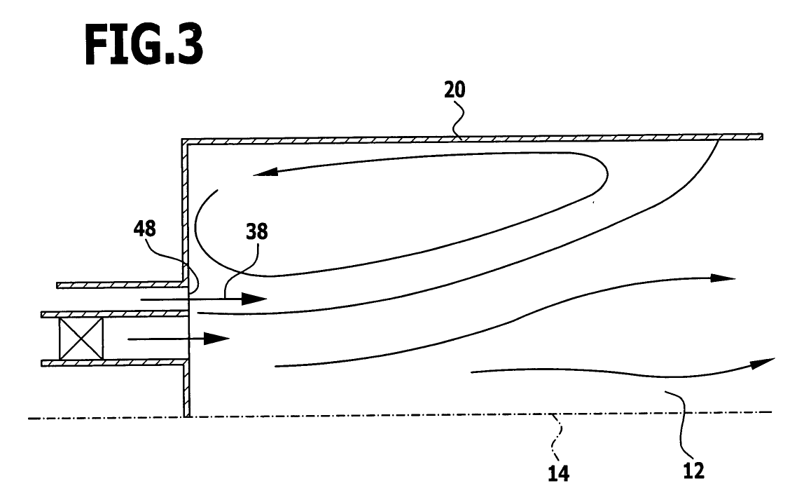

It is also possible, in principle, that a port 48 of the control jet generating device 34 is arranged in the combustion space 12 between the blowing device 24 and the transverse combustion chamber wall, as shown in FIG. 3.

It is also possible that medium for a control jet is blown into the combustion space 12 through the port 26, so that the control jet is generated in the combustion space 12 at the port 26. For this the pressure application device 40 is connected to the conduit 27 so that control jet medium can be fed to the conduit 27 before entry into the combustion space 12 (not shown in the drawing).

If a multiplicity of ports are provided, then a combination of such positioning arrangements of the ports is also possible.

The fuel and/or oxidiser is blown into the combustion space 12 by means of the blowing device 24 in particular with swirl (as swirling flow). The swirl is generated by the device 28.

The method according to the invention works as follows:

The ports 36 and 48 are circular (in the form of a hollow circular disc) or ring-shaped (in the form of a hollow ring).

A blow jet is generated as control jet 38 by the control jet generating device 34. In this case, a medium in fluid form or a plurality of media in fluid form is/are blown into the combustion space 12 (intermittently). The medium or media can be blown in in gas form, as a liquid or as a two-phase mixture of gas and liquid. The type of medium blown in is dependent on the application. For example, fuel is blown in or one or more fuel components are blown in in the case of multicomponent fuel. It is also possible that oxidiser is blown in to generate the control jet 38. Moreover, it is possible that a fuel-oxidiser mixture is blown in to generate the control jet 38. In addition, it can be provided in certain applications that an inert medium is blown in, i.e. a medium is blown in that does not participate in the combustion of fuel and oxidiser in the combustion space 12. For example, an inert gas such as nitrogen is blown in or water in vapour form or in liquid form (in particular in droplet form) is blown in.

The control jet 38 is generated temporarily in the combustion space 12 so that it has a positive influence on the flow of fuel and oxidiser in the combustion space 12. The control jet 38 is blown in axially, for example.

For example, it is provided that it is blown in so that the degree of swirl of the flow of fuel and/oxidiser generated by means of the blowing device 24 is reduced. This allows a backflow zone 50 to be expanded, and in particular axially expanded, in comparison to the control jet-free state (FIG. 1). The ignition can be improved as a result of this. In particular, the backflow zone 50 can be expanded so that a higher component of fuel and oxidiser is present at the ignition device 22 in order to facilitate the ignition.

A flushing out of the flame core formed in front of the ignition device 22 is prevented by the expanded backflow zone 50. The flame core is transported in the direction of the main reaction zone 31 by the backflow. Moreover, the risk of quenching the flame core formed is significantly reduced by a reduction of the flow rate in front of the ignition device 22.

If fuel and/or oxidiser is blown into the combustion space 12 in swirling flow by means of the blowing device 24, then the control jet 38 is able to readily influence the flow conditions in the combustion space 12, since the flow properties of swirling flows are very sensitive with respect to entry boundary conditions. The control jet 38 can influence these entry boundary conditions with a low amount of medium so that the backflow zone 50 is expanded in comparison to the backflow zone 30. The mass flow component of the control jet amounts to between 1% and 20%, and in particular 1% and 7%, or 2% and 7% of the total mass flow.

The control jet 38 or the control jets 38 are generated in such a way, and the control jet generating device 34 with its port 36 or 48 or its ports is configured accordingly, that optimised conditions result for ignition of the combustion. In particular, the control jet acts on the combustion space 12 in such a way that there result high residence times for fuel and oxidiser in the combustion space 12. Advantageously, the control jet 38 is generated so that residence times can be increased by more than 1 ms, and in particular by more than 5 ms, and in particular by more than 10 ms compared to the control jet-free state. Appropriate adjustment of the control jet generation, wherein the control jet 38 is generated in a spatially defined manner, can prevent a flame core from being flushed out. Moreover, quenching of the flame core during combustion can be prevented.

The combustion chamber according to the invention and the method according to the invention can be advantageously used in fluid combustion and in particular in association with a gas turbine. The combustion chamber device 32 according to the invention is then part of the gas turbine.

Moreover, the combustion chamber device 32 according to the invention and the method according to the invention can be used in an advantageous manner in an aircraft engine and in particular in an aeroplane engine. The backflow zone 50 can be extended in length by the at least one control jet 38 provided according to the invention. As a result of this, it is possible for optimised flow conditions to be adjusted in the combustion space 12 for ignition. This in turn enables the length of the corresponding combustion chamber 37 to be minimised.

Moreover, because of the expansion of the backflow zone 50 re-ignition at high altitudes (in which the temperature of the oxidiser in the form of air that can be supplied is substantially reduced) can be assured, since the residence times are increased for fuel vaporisation because of the expanded backflow zone 50.

The generation of a control jet 38 can be time-controlled in particular by means of the control device 44. A control jet 38 is generated or not generated, depending on the switching of the switchable valves 42. As a result, it is possible, for example, to switch off a control jet 38 after its generation if an ignition of the fuel-oxidiser mixture occurs in the combustion space 12.

Moreover, by corresponding actuation of the valve 42 it is possible to adapt the control jet 38, adapted in its generation with respect to time, to a load state of the combustion chamber 32.

In addition, it is also possible, for example, by time-pulsed actuation of the valves 42 to generate a time-pulsed control jet 38 in particular during an ignition phase. Such a pulsed control jet 38 has a stabilised effect on the flow conditions and combustion conditions in the combustion space 12, for example, and can also promote mixing of the fuel and oxidiser in the combustion space 12.

In this case, it is possible, in principle, that the control jet 38 is generated with or without swirling flow.

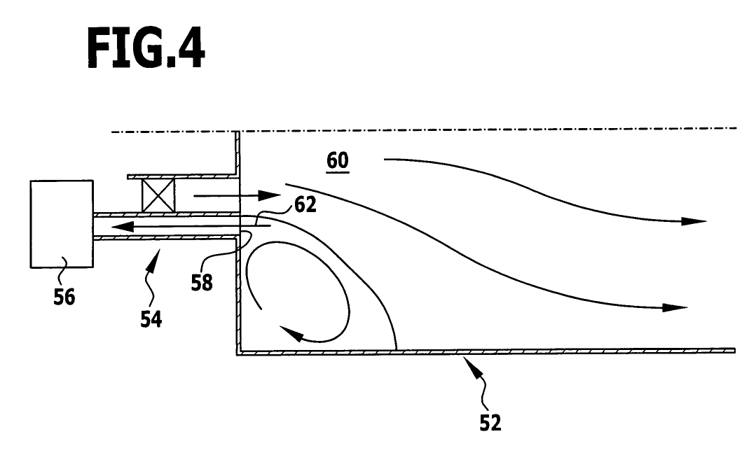

In a third exemplary embodiment of a combustion chamber device according to the invention, which is shown schematically in partial section in FIG. 4 and is given the reference 52 there, a control jet generating device 54 is provided, which comprises an underpressure application device 56. This is fluidically connected to a combustion space 60 of the combustion chamber device 52 by means of a port 58. The port 58 can have an associated valve like the above-described valve 42 (not shown in FIG. 4).

A suction jet 62 serving as a control jet to influence the flow conditions in the combustion space 60 can be generated by means of the underpressure application device 56 by applying an underpressure to the combustion space 60.

Fuel and/or oxidiser and/or combustion product is extracted from the combustion space 60 by means of the suction jet 62. In this case, the control jet generating device 54 is arranged and configured so that the flow conditions are positively influenced in particular to obtain high residence times for fuel and oxidiser in the combustion space 60 while minimising the combustion chamber length 52. Moreover, flushing of a flame core out of the combustion space 60 and quenching of the flame core in the combustion space 60 can be prevented with suitable adjustment.

As a result of the solution according to the invention with one control jet, wherein the at least one control jet can be configured as suction jet 62 or as blow jet 38, the ignition can be improved even if the ignition device 22 cannot be positioned in an optimum position, for example, because of structural limitations. A suitable mixture of fuel and oxidiser can be provided at the ignition device 22 by means of one or more control jets.

For example, such an optimisation can also be performed to control the combustion if the fuel is blown into the combustion space 12 in liquid form. It is important here to effect the ignition in regions, in which sufficiently vaporised fuel is available. An adequate residence time of the blown-in fuel droplets must be available in the combustion space 12 for vaporisation of the fuel. This in turn causes the length of the combustion space to be determined by the requirements of the ignition process when using liquid fuel. As a result of the solution according to the invention, the length of the combustion space can be significantly reduced because of the influence of the flow conditions in the combustion space 12.

In addition, optimum flow conditions can be achieved for the ignition without the combustion stability and/or pollutant emission being substantially adversely influenced.

The solution according to the invention can be used in a plurality of combustion chamber applications. For example, small burners such as in domestic burner systems can be equipped accordingly. Combustion chambers of stationary gas turbines or mobile gas turbines can also be equipped accordingly.

One or more control jets can be generated permanently or only intermittently. For example, a switch off of a control jet can occur after ignition has occurred. It can also be provided that one or more control jets are generated in permanent operation and additional control jets are generated only intermittently.

1. Method for controlling the combustion in a combustion chamber with a combustion space, comprising:
blowing fuel in fluid form and oxidiser in fluid form into the combustion space;
generating at least one control jet in the combustion space, which influences the flow of at least one of fuel and oxidiser in the combustion space;
wherein the mass flow component of the at least one control jet lies between 1% and 7% of the total mass flow;
generating the at least one control jet such that it varies over time;
generating the at least one control jet by blowing in or extracting through one or more ports in a combustion chamber wall, which coincide with one or more ports for at least one of (i) blowing in and (ii) extracting at least one of fuel and oxidiser; and
generating the at least one control jet so that a degree of swirl of at least one of the fuel flow and oxidiser flow is reduced by means of the at least one control jet.

2. Method according to claim 1, wherein the at least one control jet is generated by at least one of (i) blowing fuel or one or more fuel components into the combustion space, (ii) blowing oxidiser into the combustion space, (iii) blowing a fuel-oxidiser mixture into the combustion space, (iv) blowing one or more media into the combustion space, which do not participate in the combustion.

3. Method according to claim 1, wherein the at least one control jet is directed in a spatially defined manner.

4. Method according to claim 1, wherein the at least one control jet is directed at least approximately parallel to an axis of the combustion space or a burner.

5. Method according to claim 1, wherein the at least one control jet is generated so that one or more backflow zones in the combustion space are modified at least in their axial extent in comparison to the control jet-free state, and in particular that the at least one control jet is generated so that one or more backflow zones in the combustion space are expanded at least in their axial extent in comparison to the control jet-free state, and in particular that the at least one control jet is generated so that one or more backflow zones are expanded in the vicinity of a wall of the combustion chamber.

6. Method according to claim 1, wherein the at least one control jet is generated so that by means thereof an increase in residence times in the combustion space by more than 1 ms, or more than 3 ms, or more than 5 ms, or more than 10 ms occurs for an amount of fuel and an amount of oxidiser blown in compared to the control jet-free state.

7. Method according to claim 1, wherein the at least one control jet is generated so that by means of the at least one control jet at least one of (i) flushing of a flame core out of the combustion space is prevented, (ii) quenching of a flame core is prevented.

8. Method according to claim 1, wherein the generation of the at least one control jet is adapted to be switched on and switched off, and in particular that the at least one control jet is switched off after ignition of the fuel has occurred in the combustion space.

9. Method according to claim 1, wherein the at least one control jet generated is adapted to load change processes, and in particular the at least one control jet generated is controlled by means of the load state.

10. Method according to claim 1, wherein the at least one control jet is used for at least one of ignition and re-ignition.

11. Combustion chamber device, comprising:
a combustion space for the combustion of fuel and oxidiser;
a blowing device by means of which fuel in fluid form and oxidiser in fluid form is adapted to be blown into the combustion space;
a control jet generating device by means of which at least one control jet is generated in the combustion space, by means of which the course of flow of at least one of fuel and oxidiser in the combustion space is influenced; and
a control device, by means of which the generation of control jets is temporally controlled;
wherein at least one port for the at least one control jet opens into the combustion space and the at least one port for the at least one control jet is a port of a blowing device for fuel and oxidiser.

12. Combustion chamber device according to claim 11, wherein the control jet generating device has at least one of an underpressure application device for generating at least one suction jet as control jet, and a pressure application device for generating at least one blow jet as control jet.

13. Combustion chamber device according to claim 12, wherein one or more switchable valves, and in particular one or more magnetic valves, are associated with the at least one port.

14. Combustion chamber device according to claim 12, wherein an ignition device is provided, which is arranged on one side of the combustion chamber, which is transverse to a front side.
